(19) United States
(12) Patent Application Publication
(10) Pub. No.: US 2017/0170861 A1
(43) Pub. Date: Jun. 15, 2017

(54) TOUCH SCREEN PROTECTION SYSTEM

(71) Applicant: Audrey McAphee, East Providence, RI (US)

(72) Inventor: Audrey McAphee, East Providence, RI (US)

(21) Appl. No.: 14/963,860

(22) Filed: Dec. 9, 2015

(51) Int. Cl. H04B 1/3888; G06F 3/041

(52) U.S. Cl. CPC H04B 1/3888; G06F 3/041; G06F 2203/04107; H04M 2250/22

(57) ABSTRACT

A touch screen protection system includes a case. An electronic device is provided and the electronic device has a touch screen. The electronic device is removably positioned within the case such that the touch screen is accessible. A shield is coupled to the case. The shield is positionable in a covering position such that the shield covers the touch screen. Thus, the shield may inhibit the touch screen from being touched. The shield is positionable in an exposing position such that the touch screen is exposed.

### BACKGROUND OF THE DISCLOSURE

### Field of the Disclosure

The disclosure relates to touch screen devices and more particularly pertains to a new touch screen device for inhibiting a touch screen from being inadvertently manipulated.

### SUMMARY OF THE DISCLOSURE

An embodiment of the disclosure meets the needs presented above by generally comprising a case. An electronic device is provided and the electronic device has a touch screen. The electronic device is removably positioned within the case such that the touch screen is accessible. A shield is coupled to the case. The shield is positionable in a covering position such that the shield covers the touch screen. Thus, the shield may inhibit the touch screen from being touched. The shield is positionable in an exposing position such that the touch screen is exposed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a touch screen protection system according to an embodiment of the disclosure.

FIG. 2 is a top view of an embodiment of the disclosure.

FIG. 3 is a perspective in-use view of an embodiment of the disclosure.

FIG. 4 is a back view of an embodiment of the disclosure.

FIG. 5 is a left side view of an embodiment of the disclosure.

### DESCRIPTION OF THE PREFERRED EMBODIMENT

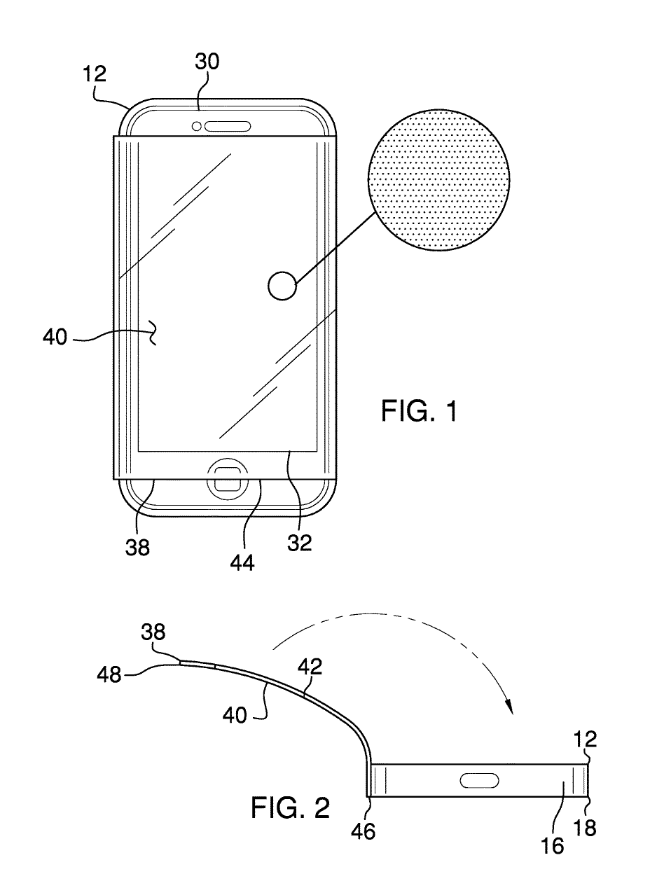

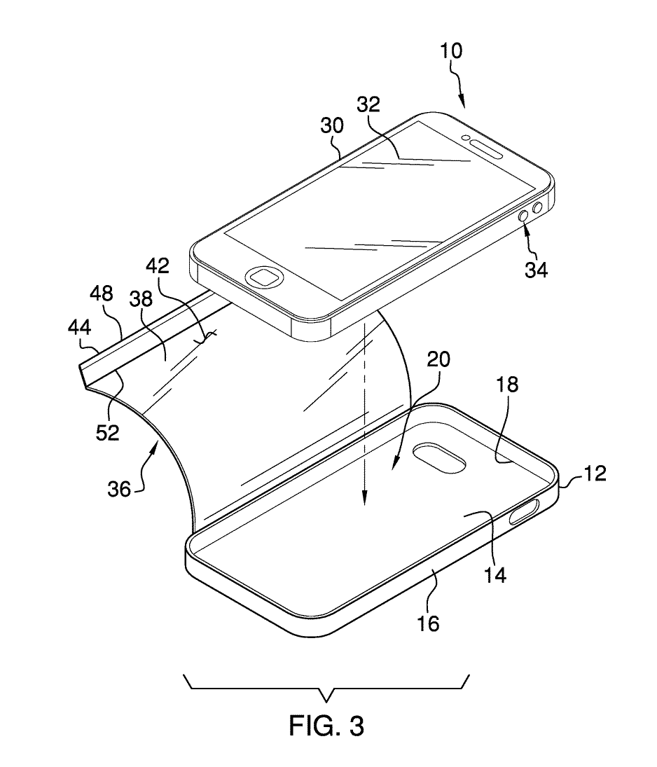

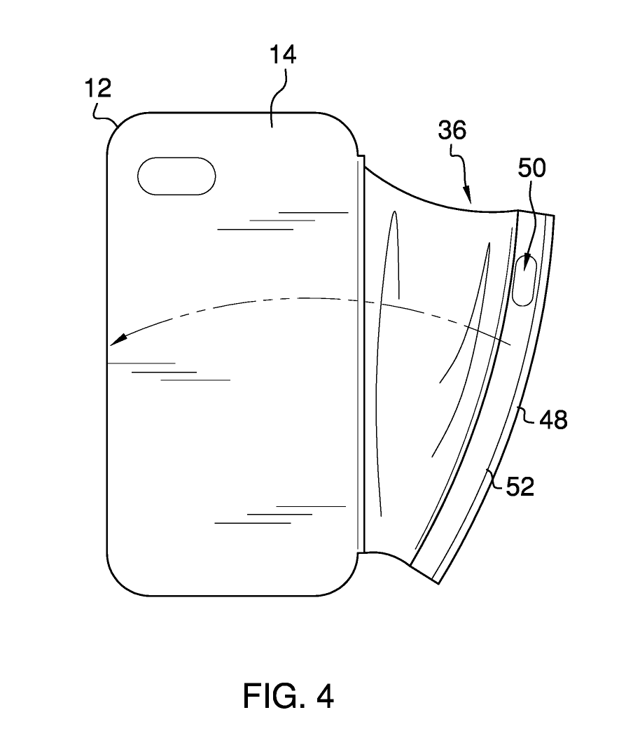

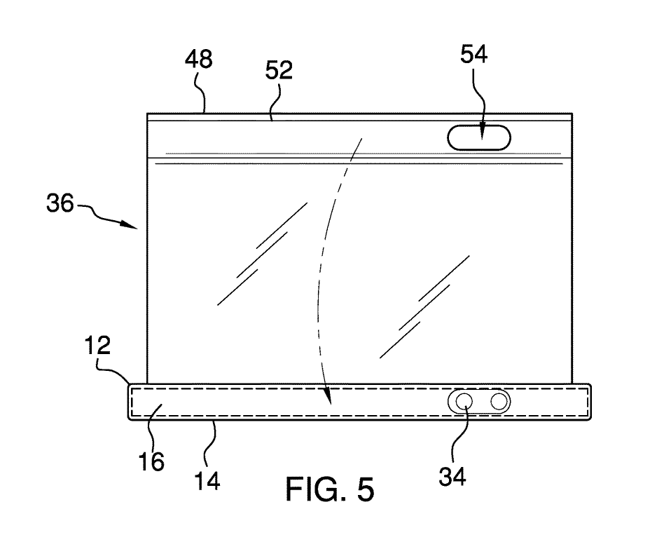

With reference now to the drawings, and in particular to FIGS. 1 through 5 thereof, a new touch screen device embodying the principles and concepts of an embodiment of the disclosure and generally designated by the reference numeral 10 will be described.

As best illustrated in FIGS. 1 through 5, the touch screen protection system 10 generally comprises a case 12 that has a back wall 14 and a perimeter wall 16 that is coupled to and extends away from the back wall 14. The perimeter wall 16 is coextensive with an outer edge 18 of the back wall 14 to define a space 20 within the case 12. The perimeter wall 16 has a first lateral side 22, a second lateral side 24 and an outer surface 26. The perimeter wall 16 has an aperture 28 extending into the space 20. The case 12 may comprise a smart phone case or the like.

An electronic device 30 is provided. The electronic device 30 has a touch screen 32. The electronic device 30 is removably positioned within the case 12 such that the touch screen 32 is accessible. The electronic device 30 includes a control 34. The control 34 is aligned with the aperture 28 when the electronic device 30 is positioned space 20. Thus, the control 34 may be manipulated. The electronic device 30 may comprise a smart phone or the like.

A shield 36 is movably coupled to the case 12. The shield 36 is positionable in a covering position such that the shield 36 covers the touch screen 32. Thus, the shield 36 inhibits the touch screen 32 from being touched. The shield 36 is positionable in an exposing position such that the touch screen 32 is exposed.

The shield 36 comprises a sheet 38 that has a top surface 40, a bottom surface 42 and a peripheral edge 44 extending between the top surface 40 and the bottom surface 42. The peripheral edge 44 has a first side 46 and a second side 48. The bottom surface 42 is coupled to the outer surface 26 of the case 12 corresponding to the first lateral side 22. The sheet 36 extends across the space 20 and downwardly along the second lateral side 24 when the shield 36 is positioned in the covering position. The bottom surface 42 lies on the touch screen 32 when the shield 36 is positioned in the covering position.

The sheet 38 has an opening 50 extending through the top surface 40 and the bottom surface 42. The opening 50 is positioned closer to the second side 48 than the first side 46. The opening 50 is aligned with the aperture 28 when the shield 36 is positioned in the covering position. The sheet 38 is comprised of mesh material such that the touch screen 32 is visible through the sheet 38 when the shield 36 is positioned in the covering position.

A coupler 52 is coupled to the bottom surface 42 and the coupler 52 is substantially coextensive with the second side 48. The coupler 52 releasably engages the second lateral side 24 of the case 12 when the shield 36 is positioned in the covering position. Thus, the sheet 38 is retained to cover the touch screen 32. The coupler 52 has an opening 54 extending therethrough. The opening 54 corresponding to the coupler 52 is aligned with the opening 50 corresponding to the sheet 38.

The case 12 may be comprised of a magnetic material. The coupler 52 may comprise a magnet. Thus, the coupler 52 may magnetically engage the case 12 when the shield 36 is positioned on the covering position. The coupler 52 may comprise a clip that frictionally engages the case 12 when the shield 36 is positioned in the covering position.

In use, the electronic device 30 is positioned within the case 12. The shield 36 is positioned in the covering position when a phone call has been placed on the electronic device 30. The shield 36 inhibits a user from contacting the touch screen 32 with the user's face. Thus, the shield 36 inhibits the user from inadvertently terminating the phone call and inadvertently actuating icons on the touch screen 32 during the phone call. The shield 36 is positioned in the exposing position when the touch screen 32 is to be manipulated.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A touch screen protection system comprising:
a case, said case has a back wall and a perimeter wall being coupled to and extending away from said back wall, said perimeter wall being coextensive with an outer edge of said back wall to define a space in said case, said perimeter wall having a first lateral side, a second lateral side and an outer surface, said perimeter wall having an aperture extending into said space through said second lateral side;
an electronic device having a touch screen, said electronic device being removably positioned within said case such that said touch screen is accessible;
a shield being coupled to said case, said shield being positionable in a covering position such that said shield covers said touch screen wherein said shield is configured to inhibit said touch screen from being touched, said shield being positionable in an exposing position such that said touch screen is exposed, said shield comprising a sheet having a top surface, a bottom surface and a peripheral edge extending between said top surface and said bottom surface, said peripheral edge having a first side and a second side, said bottom surface being coupled to said outer surface of said case corresponding to said first lateral side, said sheet extending across said space and downwardly along said second lateral side when said shield is positioned in said covering position having said bottom surface lying on said touch screen; and
an opening extending through said top surface and said bottom surface of said sheet, said opening being positioned closer to said second side than said first side, said opening being aligned with said aperture when said shield is positioned in said covering position such that a portion of said sheet overlaps and extends along said second lateral side of said perimeter wall of said case.

2. (canceled)

3. The system according to claim 2, wherein said electronic device includes a control, said control being aligned with said aperture when said electronic device is positioned space wherein said control is configured to be manipulated.

4. (canceled)

5. (canceled)

6. The system according to claim 1, further comprising said covering position, said sheet being comprised of mesh material such that said touch screen is visible through said sheet when said shield is positioned in said covering position.

7. The system according to claim 1, further comprising a coupler being coupled to said bottom surface, said coupler being substantially coextensive with said second side, said coupler releasably engaging said second lateral side of said case when said shield is positioned in said covering position such that said sheet is retained to cover said touch screen.

8. The system according to claim 7, wherein said coupler has an opening extending therethrough, said opening corresponding to said coupler being aligned with said opening corresponding to said sheet.

9. A touch screen protection system comprising:
a case having a back wall and a perimeter wall being coupled to and extending away from said back wall, said perimeter wall being coextensive with an outer edge of said back wall to define a space in said case, said perimeter wall having a first lateral side, a second lateral side and an outer surface, said perimeter wall having an aperture extending into said space through said second lateral side;
an electronic device having a touch screen, said electronic device being removably positioned within said case such that said touch screen is accessible, said electronic device including a control, said control being aligned with said aperture when said electronic device is positioned space wherein said control is configured to be manipulated; and
a shield being coupled to said case, said shield being positionable in a covering position such that said shield covers said touch screen wherein said shield is configured to inhibit said touch screen from being touched, said shield being positionable in an exposing position such that said touch screen is exposed, said shield comprising:
a sheet having a top surface, a bottom surface and a peripheral edge extending between said top surface and said bottom surface, said peripheral edge having a first side and a second side, said bottom surface being coupled to said outer surface of said case corresponding to said first lateral side, said sheet extending across said space and downwardly along said second lateral side when said shield is positioned in said covering position having said bottom surface lying on said touch screen, said sheet having an opening extending through said top surface and said bottom surface, said opening being positioned closer to said second side than said first side, said opening being aligned with said aperture when said shield is positioned in said covering position such that a portion of said sheet overlaps and extends along said second lateral side of said perimeter wall of said case, said sheet being comprised of mesh material such that said touch screen is visible through said sheet when said shield is positioned in said covering position, and
a coupler being coupled to said bottom surface, said coupler being substantially coextensive with said second side, said coupler releasably engaging said second lateral side of said case when said shield is positioned in said covering position such that said sheet is retained to cover said touch screen, said coupler having an opening extending therethrough, said opening corresponding to said coupler being aligned with said opening corresponding to said sheet.
